(19) United States
(12) Patent Application Publication
(10) Pub. No.: US 2026/0246527 A1
(43) Pub. Date: Aug. 20, 2026

(54) DELAY-DOMAIN ESTIMATION OF MOVEMENT OF AN ANTENNA STRUCTURE WITH A DIRECTIVE ANTENNA MOUNTED THERETO

(71) Applicant: Telefonaktiebolaget LM Ericsson (publ), Stockholm (SE)

(72) Inventors: Sven Jacobsson, Västra Frölunda (SE); Sam Agneessens, Torslanda (SE); Andreas Nilsson, Göteborg (SE); Oskar Talcoth, Göteborg (SE); Mikael Coldrey, Borås (SE); Magnus Nilsson, Kungsbacka (SE)

(21) Appl. No.: 19/471,146

(22) PCT Filed: Apr. 3, 2023
(86) PCT No.: PCT/EP2023/058611

§ 371 Date: Sep. 30, 2025

(51) Int. Cl. H04B 7/06; H04W 16/28

(52) U.S. Cl. CPC H04B 7/06952; H04W 16/28

(57) ABSTRACT

A computer-implemented method for enabling compensation of a movement of a first antenna structure having a first antenna mounted thereto, and a node performing such method. The first antenna is configured to communicate with a second antenna over a first wireless communication channel. The method comprises obtaining a difference in propagation delay of a first signal over the first wireless communication channel relative to a first reference delay, and estimating the movement of the first antenna structure based on the estimated difference in propagation delay of the first signal.

### TECHNICAL FIELD

The present disclosure relates generally to the field of wireless communication. More particularly, the present disclosure relates to a method for enabling compensating movement of an antenna structure having an antenna mounted thereto, a node performing such method, a computer program product, and a computer program carrier.

### BACKGROUND

Point-to-point links at high frequencies, e.g., at E-band, W-band or D-band, need to rely on high-directivity antennas (e.g., >50 dBi) to get sufficient link gain to be able to reach large distances, high capacities, and/or high availability. High-directivity antennas have very narrow main beams (e.g. 0.5 degrees half-power beam width for a 60 cm 50 dBi E-band antenna). This makes a communication link between two directive antennas sensitive to antenna misalignment or movement (such as sway) of one or both of the antenna structures (such as masts) which the respective directive antennas are mounted onto. When an antenna structure moves, an antenna mounted onto that antenna structure also moves. Movement of the antenna in a longitudinal direction towards and away from the other node in the link and movement of the antenna in the form of rotation in the horizontal plane relative to the direction towards the other node in the link typically causes misalignment. Movement in the longitudinal direction may also be called tilt or rotation in the vertical plane. Rotation in the horizontal plane may also be called twist. The misalignment or movement causes fading dips that temporarily reduce link gain and hence a capability to sustain a certain communication rate (or fade margin necessary to achieve a targeted availability).

One way of mitigating the problem of movement of one or both of the antenna structures is to provide one or both of the directive antennas with a misalignment/movement compensation system. Such a system should be able to detect the sway or movement of the associated antenna structure, compute a required compensation, and take action such as redirecting the beam of the directive antenna mounted on the associated antenna structure.

Different approaches exist to detect and determine how much an antenna is moving or has rotated.

One approach is to rely on the antenna pattern to detect the angle of arrival, which is equivalent to the movement of the antenna in a fixed-service point-to-point system. The radio receiver is used as a sensor to detect the received signal strength (RSS), which is then used to determine the direction of the other node of the communication link.

One example of using the antenna pattern is a conical scanning system. In such a system, the beam of an antenna is rotated rapidly around the boresight direction. This generates an amplitude modulated signal which may be used to extract the angle of arrival of the antenna. If only lateral movement needs to be detected, for example a mast that only swings in the vertical plane including the two masts of the link, the system has to scan quickly up and down to find the direction of the transmitter at the other side of the communication link.

One example of using the antenna pattern is using a mono-pulse system. Such a system may track a target, or detect antenna movement, by means of multiple fixed beams. The system uses at least four feed antennas in combination with a feed network to sum and difference beams which are used to generate an error signal which in turn may be used to calculate the angle of arrival.

However, methods relying on RSS and a moving antenna pattern require fast beam scanning. This poses tough requirements on the durability of the antenna system, especially if the beam steering involves mechanically moving parts. In addition, any method that entails scanning the antenna pattern to find the direction of the receiver has the drawback that it will cause fluctuation of the RSS, which may reduce the link gain, which impacts link performance such as capacity, availability, and distance. Mono-pulse systems require multiple feed antennas, a comparator network and additional radio frequency (RF) circuitry (e.g., downconverter, oscillators, etc.) to compute the error signals. These add significant cost, complexity, and losses.

Another approach to detect and determine how much an antenna is moving is disclosed in WO2021173050A1, which discloses a method using a motion sensor to detect antenna movement, and steering the beam of the antenna based on the motion sensor output.

However, motion sensors with sufficiently fine resolution are expensive and may be overly sensitive to vibrations of the antenna or mounting pole. Sensor impairments such as sensor drift may make the beam steering unreliable.

Considering the disadvantages mentioned above, there is a need for improved ways of estimating and compensating for movement of an antenna structure having a directive antenna mounted thereto.

### SUMMARY

It is an object of the present disclosure to mitigate, alleviate or eliminate one or more of the above-identified deficiencies and disadvantages in the prior art and solve at least the above-mentioned problem. This object is obtained at least in part by a computer-implemented method for enabling compensation of a movement of a first antenna structure having a first antenna mounted thereto. The first antenna is configured to communicate with a second antenna over a first wireless communication channel. The method comprises obtaining a difference in propagation delay of a first signal over the first wireless communication channel relative to a first reference delay, and estimating the movement of the first antenna structure based on the estimated difference in propagation delay of the first signal.

The difference in propagation delay of the first signal gives information of a direction in which a beam of the first antenna has moved. This is not possible to detect using RSS alone without beam scanning.

Weather conditions along the communication channel may impact the RSS (e.g., attenuation due to rain). However, weather conditions typically does not impact the propagation delay of the communication channel. Consequentially, the disclosed method enables distinguishing if a drop in RSS originates from a change in weather conditions or from movement of the first antenna structure.

The disclosed method does not require any motion sensors, such as inertial measurement units (IMUs), to estimate the movement of the first antenna structure. The movement estimation may be done entirely by using existing hardware, e.g., in a first radio unit associated with the first antenna and/or in a remote data processing unit. Consequently, the disclosed method is more cost-effective compared to prior art solutions.

The movement of antenna structures may be estimated for multiple antenna structures of multiple links. With such information, an operator may make a fact-based decision on which links need to be upgraded with a movement compensation system and which may do without.

In some embodiments, a motion sensor is additionally comprised in the first antenna structure for complementing the estimation of the movement of the first antenna structure. The disclosed method enables relaxed requirements of such a motion sensor. For example, an inexpensive and less accurate motion sensor may be used. The difference in propagation delay of the first signal may e.g. be used to compensate for sensor drift of the motion sensor. Alternatively, or in combination of, slow movements of the antenna structure may be estimated using the motion sensor and faster movements of the antenna structure may be estimated using the difference in propagation delay of the first signal.

The difference in propagation delay may be used to detect atmospheric ducting when combined with motion sensors. Atmospheric ducting cannot be detected if only motion sensors are exploited.

The computer-implemented method may further comprise controlling, based on the estimated movement of the first antenna structure, a beam direction of the first antenna such that the movement of the first antenna structure is compensated for. In this way, the beam direction of the first antenna is controlled such that any misalignment caused by the movement of the first antenna structure is compensated for. The disclosed method reduces speed requirements of the controlling the beam direction of the first antenna. If the beam direction is controlled by mechanical means, the reduced speed enables a longer lifetime of the mechanical means, and enables the use of inexpensive solutions.

Since the propagation delay estimation is unaffected by changes in RSS, the disclosed method may be combined with beam scanning. As an example, the difference in propagation delay of the first signal may be used for estimating a vertical misalignment of a beam of the first antenna, while beam scanning is used to realign the beam in the horizontal direction. In that case, the beam scanning procedure is reduced from two dimensions to one dimension, which is a considerable simplification.

There is also disclosed herein a node for enabling compensation of a movement of a first antenna structure having a first antenna mounted thereto. The node is associated with the above-discussed advantages. The first antenna is configured to communicate with a second antenna over a first wireless communication channel. The node comprises a processing circuitry and a memory. The processing circuitry is configured to obtain a difference in propagation delay of a first signal over the first wireless communication channel relative to a first reference delay, and estimate the movement of the first antenna structure based on the estimated difference in propagation delay of the first signal.

The processing circuitry may be configured to control, based on the estimated movement of the first antenna structure, a beam direction of the first antenna such that the movement of the first antenna structure is compensated for.

There is also disclosed herein a computer program product comprising instructions which, when executed on at least one processing circuitry, cause the at least one processing circuitry to carry out the method according to the discussion above. The computer program is associated with the above-discussed advantages.

There is also disclosed herein a computer program carrier carrying a computer program product according to the discussion above, wherein the computer program carrier is one of an electronic signal, optical signal, radio signal, or computer-readable storage medium. The computer program carrier is associated with the above-discussed advantages.

### BRIEF DESCRIPTION OF THE DRAWINGS

With reference to the appended drawings, below follows a more detailed description of embodiments of the present disclosure cited as examples. In the drawings:

FIGS. 1A and 1B show schematic illustrations of different scenarios of a wireless communications network;

FIG. 2 shows a schematic illustration of a wireless communications network;

FIG. 3 shows an example radiation pattern;

FIG. 4 is a plot showing sway, distance, and fade versus time;

FIG. 5 is a plot showing amplitude versus samples for different channel measurements;

FIG. 6 is a plot showing sway versus time before and after de-biasing;

FIG. 7 shows an example block diagram of a clock recovery filter;

FIGS. 8A-8C show different examples of sampling;

FIG. 9 is a flow chart illustrating a method;

FIG. 10 schematically illustrates a radio unit; and

FIG. 11 schematically illustrates a remote data processing unit.

### DETAILED DESCRIPTION

The present disclosure is described below with reference to the accompanying drawings, in which certain aspects of the present disclosure are shown. The present disclosure may, however, be embodied in many different forms and should not be construed as limited to the embodiments and aspects set forth herein; rather, these embodiments are provided by way of example so that this disclosure will be thorough and complete, and will fully convey the scope of the present disclosure to those skilled in the art. Like numbers refer to like elements throughout the description.

It is to be understood that the present disclosure is not limited to the embodiments described herein and illustrated in the drawings; rather, the skilled person will recognize that many changes and modifications may be made within the scope of the appended claims.

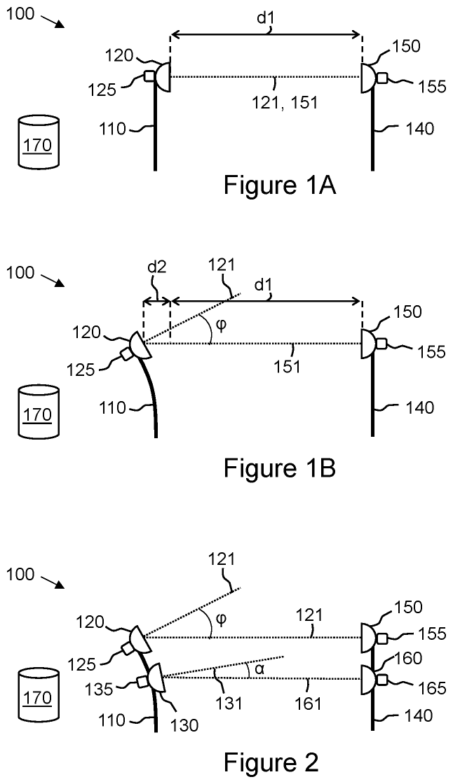

FIGS. 1A and 1B depict different scenarios of a wireless communications network 100 in which embodiments herein may operate. In some embodiments, the wireless communications network 100 may be a radio communications network, such as, 6G, NR or NR+ telecommunications network. However, the wireless communications network 100 may also employ technology of any one of 3/4/5G, LTE, LTE-Advanced, WCDMA, GSM/EDGE, WiMax, UMB, GSM, or any other similar network or system. The wireless communications network 100 may also employ technology transmitting on millimeter-waves (mmW), such as, e.g. an Ultra Dense Network, UDN. In some embodiments, the wireless communications network 100 may also employ transmissions supporting WiFi transmissions, e.g. the wireless communications standard IEEE 802.11ad or similar, or other non-cellular wireless transmissions.

The wireless communications network 100 comprises a first radio unit 125 associated with a first antenna 120. The first antenna 120 is a directive antenna. A directive antenna is an antenna that radiates or receives a larger amount of radio wave power in a specific direction compared to other directions. A directive antenna may also be called a directional antenna, a beam antenna, or a high-gain antenna. In contrast to alow-gain antenna, which is an antenna with a broad beam width, a directive antenna has a relatively narrow beam width. As an example, a directive antenna may have a 0.1 to 10 degrees half-power beam width. Other beam widths are also possible.

In FIGS. 1A and 1B, the first antenna 120 is configured to communicate with a second antenna 150 in the wireless communications network 100 via a first communication channel. The second antenna 150 is associated with a second radio unit 155. The first radio unit 125 is thus capable of communicating with the second radio unit 155 over a radio link. The first radio unit 125 may transmit and receive data over an air or radio interface to/from the second radio unit 155. Similarly, the second radio unit 155 may transmit and receive data over the air or radio interface to/from the first radio unit 125.

The first and/or the second radio units 125, 155 may be arranged to communicate with a remote data processing unit 170, e.g. via a core network of the wireless communications network 100 and/or via high-capacity backhaul links (such as fiber optic cables). The remote data processing unit 170 may e.g. be a remote standalone server, a cloud-implemented server, a distributed server, dedicated data processing resources in a server farm, or similar.

In FIGS. 1A and 1B, the second antenna 150 is a directive antenna. However, in embodiments disclosed herein, the second antenna 150 may be any type of antenna. Compensating misalignment of the first antenna 120 is desired irrespective whether the second antenna 150 is directive or omnidirectional.

As is further shown in FIG. 1A, a beam direction 121 of the first antenna 120 point towards the second antenna 150 and is aligned with a beam direction 151 of the second antenna 150. The beam direction of a directive antenna is the axis of maximum gain (i.e. the axis of maximum radiated power) of the directive antenna. The beam direction may also be called the antenna boresight.

The first antenna 120 is mounted on a first antenna structure 110. The second antenna 150 is mounted on a second antenna structure 140. An antenna structure is a structure designed to support antennas for telecommunications. An antenna structure may e.g. be guyed or self-supporting structure. An antenna structure may e.g. be in the form of a mast or a tower.

In FIGS. 1A and 1B, the first ratio unit 125 is attached to the first antenna 120 and the second radio unit 155 is attached to the second antenna 150. In general, however, the first radio unit 125 may be attached anywhere on the first antenna structure 110 or be arranged separately from the first antenna structure 110. In any case, the first radio unit 125 is arranged to transmit and receive radio signals via the first antenna 120, e.g., by the means of cables. Similarly, the second radio unit 155 may be attached anywhere on the second antenna structure 140 or be arranged separately from the second antenna structure 140. In any case, the second radio unit 155 is arranged to transmit and receive radio signals via the second antenna 150, e.g., by the means of cables.

In FIG. 1A, the first and the second antenna structures 110, 140 are stationary at intended positions that aligns the beam direction 121 of the first antenna 120 with the beam direction 151 of the second antenna 150. In FIG. 1A, the distance between the first and the second antennas 120, 150 is denoted d1. In FIG. 1B, the first antenna structure 110 has swayed, i.e. moved, relative to its intended position, e.g., due to wind. As a consequence, the beam direction 121 of the first antenna 120 is tilted by an angle cp relative to the beam direction 121 of the first antenna 120 in FIG. 1A. Due to the tilt, the beam direction 121 of the first antenna 120 is no longer aligned with the beam direction 151 of the second antenna 150.

As a part of developing the embodiments disclosed herein, the inventors have realized that the movement of the first antenna structure 110 results in the distance between the first and the second antennas 120, 150 to change relative to when both the first and the second antenna structures 110, 140 are stationary. In the example of FIG. 1B, the first antenna structure 110 has bent away from the second antenna 150 such that the distance between the first and the second antennas 120, 150 has increased by an amount d2 relative to the case in FIG. 1A. The inventors have realized that the distance d2 may be estimated from a first difference of a propagation delay of a signal in the communication channel between the first and the second antennas 120, 150 during the scenario of FIG. 1B relative to the propagation delay of a signal in the communication channel during the scenario of FIG. 1A. The propagation delay of a signal is the time duration taken for the signal to reach its destination when transmitted over a communications channel.

The distance d2 may be used as a parametrization of the movement of the first antenna structure 110. Using the estimated d2, it is possible to estimate a tilt of the first antenna 120, e.g. using the dimensions of the first antenna structure 110 and trigonometry, or a model modelling tilt versus the distance d2 (or the difference in delay). With the estimated tilt, it is possible to control the beam direction of the first antenna 120 to compensate for the movement of the first antenna structure 110. In other words, it is possible to redirect the beam direction of the first antenna 120 to compensate for the movement of the first antenna structure 110.

Some of the embodiments disclosed herein also address scenarios in which both the first and the second antenna structures 110, 140 are moving. Furthermore, some embodiments address distinguishing between which of the first and the second antenna structures 110, 140 that is moving.

When the first antenna structure 110 moves back and forth in the direction towards the second antenna 150, i.e., moving in a longitudinal direction, the communication link between the first and the second antennas 120, 150 may experience sway-induced fading. Longitudinal movement of the first antenna structure 110 typically causes the first antenna 120 to tilt relative to the second antenna 150, which results in a varying gain towards the second antenna 150 as the first antenna structure 110 is moving. Sideways sway of the first antenna structure 110 will have less impact since a lateral sideways movement has minimal impact on the beam direction of the first antenna 120. Hence, the link gain between the first antenna 120 and the second antenna 150 remains relatively constant during sideways sway of the first antenna structure 110.

The direction of the sway and the amplitude of the sway may be estimated from a magnitude and a sign of the difference in propagation delay relative to the reference delay (e.g. from when the first and the second antenna structures 110, 140 are not moving). For example, a shorter propagation delay relative to the reference delay means the first antenna 120 is moving toward the second antenna 150 and is tilting forward.

The beam direction of the first antenna 120 may e.g. be controlled by mechanically steering the first antenna 120. Controlling the beam direction may also be called sweeping the beam. The mechanical steering may e.g. be performed by controlling a two-dimensional rotating platform onto which the first antenna 120 is arranged. If the first antenna is a reflector antenna comprising a feed antenna illuminating a reflector (i.e., a metallic surface of some shape, such as parabolic), the mechanical steering may be performed by moving the feeder antenna relative to the reflector. Another way of mechanically steering a reflector antenna is to move the reflector or a sub-reflector in a multi-antenna system relative to the antenna structure.

Alternatively, or in combination of, if the first antenna 120 is in the form of an electronically steered array (ESA) antenna, the beam direction may, e.g., be controlled by controlling individual antenna elements in the ESA antenna.

In general, the propagation delay of a signal in the communication channel during the scenario of FIG. 1B may be compared to a first reference delay. The first reference delay may represent the propagation delay of a signal in the communication channel during the scenario of FIG. 1A, as discussed above. However, it may also represent any previous scenario, which, e.g., provides the highest RSS of a signal in communication channel.

Any of the signals in the communication channel used to estimate propagation delay may be transmitted from the first antenna 120 to the second antenna 150, or be transmitted by the second antenna 150 to the first antenna 120. If the propagation delay of a signal in the communication channel during the scenario of FIG. 1B is estimated from a signal transmitted from the second antenna 150 to the first antenna 120, the first radio unit 125 may estimate the movement and the antenna structure 110 and subsequently control the beam direction of the first antenna 120 without receiving any additional information from any other node. If, on the other hand, the propagation delay of a signal in the communication channel during the scenario of FIG. 1B is estimated from a signal transmitted from the first antenna 120 to the second antenna 150, the second radio unit 155 may communicate the estimated propagation delay to the first radio unit 125, which subsequently estimates the movement of the first antenna structure 110 and thereafter controls the beam direction of the first antenna 120. Alternatively, the estimated propagation delay is communicated to the first antenna 120 via the remote data processing unit 170. In yet another alternative, the remote data processing unit 170 receives the estimated propagation delay and subsequently estimates the movement of the first antenna structure 110, and thereafter communicates control signals for controlling the beam direction of the first antenna 120 to the first radio unit 125.

The signals used to estimate propagation delay may advantageously be some reference signal comprising a pilot known by the radio unit receiving the signal. However, other types of signals are also possible.

FIG. 2 shows the wireless communications network 100 of FIG. 1B, with additional antennas. In particular, FIG. 2 shows a third antenna 130 mounted on the first antenna structure 110 provided with an associated third radio unit 135, and a fourth antenna 160 provided with an associated fourth radio unit 165. A beam direction 131 of the third antenna 130 is not aligned with a beam direction 161 of the fourth antenna 160 due to the movement of the first antenna structure 110. In particular, the beam direction 131 of the third antenna 130 is tilted by an angle α relative to a line-of-sight direction to the fourth antenna 120. In FIG. 2, it is possible to use a second difference of a propagation delay of a signal in the communications channel between the third and the fourth antennas 130, 160 relative to a second reference delay, in addition the first difference of the propagation delay, to estimate the movement of the first antenna structure 110. This is discussed in more detail below.

The embodiments disclosed herein may be used to detect movement of the first antenna structure 110 in any communications channel. If this information is collected for all links in a wireless communications network, the operator may make a fact-based decision on which links need to be upgraded with a sway compensation system and which may do without.

The embodiments disclosed herein may provide additional data for analytics algorithms. For example, the estimated propagation delay may be used to improve decisions on classification of different events (e.g., wind, rain, multipath). Combined with motion sensor data it could also provide information to allow for identification of atmospheric ducting. The estimated movement of the first antenna structure 110 may also be used as an input for adaptive coding and modulation (ACM).

In an example, the first and the second antennas 120, 150 are part of a link forming a point-to-point fixed wireless connection. The first and the second antennas 120, 150 are mounted on a first and a second antenna structure 110, 140, respectively, such as respective masts. One of the first and the second antennas 120, 150 repeatedly transmits a reference signal, while the other receives the reference signal. The propagation delay is estimated from one of the reference signals received by the first antenna 120. From the variation of delay over time and the received signal power (e.g., RSS) the movement of the first antenna structure 110 is estimated.

If the first antenna 120 is a 50 dBi antenna (such as a 60 cm dish antenna) operating at E-band with a 0.5 degrees half-power beam width, a 3 dB loss in a received signal will occur when the beam direction of the first antenna 120 is tilted by 0.25 degrees relative to when the beam direction of the first antenna 120 is perfectly aligned with the beam direction of the second antenna 150. A similar gain loss for a 47 dBi antenna (such as 30 cm dish antenna) happens at 0.5 degrees tilt. Consequently, if it is desired to keep the gain drop below 3 dB, the resolution of controlling the beam direction of the first antenna 120 has to be better than the aforementioned numbers.

Table 1 below shows examples of difference in propagation delay due to a titling beam direction of the first antenna 120, where the link is an E-band link and the first antenna 120 is mounted on a swaying pole with a 20 m height. The tilt angle of the beam direction of the first antenna 120 is relative to a direction when the beam direction of the first antenna 120 is aligned with the beam direction of the second antenna 150. Similarly, the additional distance and the difference in propagation delay are relative to a reference case when the beam direction of the first antenna 120 is not tilted,

Table 2 shows the difference in propagation delay of Table 1 expressed in symbol length and samples for a system operating with a 100 MHz bandwidth and with a 1000 MHz bandwidth. Here, an oversampling rate of 32 is assumed.

TABLE 1
Path length difference and propagation delay.

| | | Additional distance | Difference in |
|---|---|---|---|
| Tilt | Additional | (number of | propagation |
| angle | distance | wavelengths | delay |
| (degrees) | (cm) | @ 80 GHz) | (ns) |
| 0.1 | 3.5 | 9.3 | 0.12 |
| 0.25 | 8.8 | 23.3 | 0.29 |
| 0.5 | 17.4 | 46.5 | 0.58 |

TABLE 2
Difference in propagation delay expressed in number of symbols and samples.

| | Difference in | Difference in | Difference in | Difference in |
|---|---|---|---|---|
| | propagation | propagation | propagation | propagation |
| Tilt | delay (number | delay (number | delay (number | delay (number |
| angle | of symbols | of samples | of symbols | of samples |
| (degrees) | @ 100 MHz) | @100 MHz) | @1000 MHz) | @1000 MHz) |
| 0.1 | 0.12 | 3.7 | 1.2 | 37 |
| 0.25 | 0.29 | 9.3 | 2.9 | 93 |
| 0.5 | 0.58 | 18.6 | 5.8 | 186 |

In some embodiments, the movement of the first antenna structure 110 is obtained from a model that models the movement of the first antenna structure 110 as a function of the difference in propagation delay. The movement outputted by the model may subsequently be used take corrective measures to counteract the movement.

In some embodiments, the first antenna 120 is steerable antenna capable of adapting its beam direction in the vertical direction. The difference in propagation delay of the first signal may be used to control the beam direction of the first antenna 120 in an opposite direction of the movement that caused the difference in propagation delay of the first signal. For example, a forward tilting antenna structure leads to a shorter distance and a shorter propagation delay (or negative difference in propagation delay) relative to when the antenna structure is stationary. The magnitude of the difference in propagation delay may be used to determine how large the movement was. The antenna beam may be scanned in the opposite direction of the tilt until a maximum received signal level is achieved again. If the received signal level drops again, without a change in the propagation delay, the steering has gone too far.

In some embodiments, the first antenna 120 is a steerable antenna, and the first radio unit 125 or the remote data processing unit 170 is provided with a model, which models the compensation needed by the antenna to maximize the received signal level for a certain propagation delay.

In some embodiments, the relation between movement of the antenna structure and the tilt angle of the first antenna 120 is known from, e.g., a physical model of the first antenna structure 110. This may be used to directly control the beam-steering of the first antenna 120. In an optional subsequent step, fine tuning of the beam direction of the first antenna 120 may be done based on a received signal strength scan.

How the first antenna structure 110 moves (e.g., bends), and hence how much tilt angle that should be applied to compensate for a certain propagation delay, may depend on, e.g., temperature differences in the first antenna structure 110. For example, the sunlit side of the first antenna structure 110 may be warmer than the side in the shade. In some embodiments, sensors are used to determine temperature differences in the first antenna structure 110. Alternatively, or in combination of, estimated temperature differences of the first antenna structure 110 is signaled by the network based on whether reports. The model used to determine the tilt angle based on the propagation delay depends, in that case, on the estimated temperature differences in the first antenna structure 110.

Calculation of the propagation delay may be performed by processing circuitry of, e.g., the first radio unit 125 or the remote data processing unit 170. The calculations may comprise estimating a shift in a Fourier transform of the received signal. Below is example of how such calculation of propagation delay may be used to estimate the movement of the first antenna structure 110.

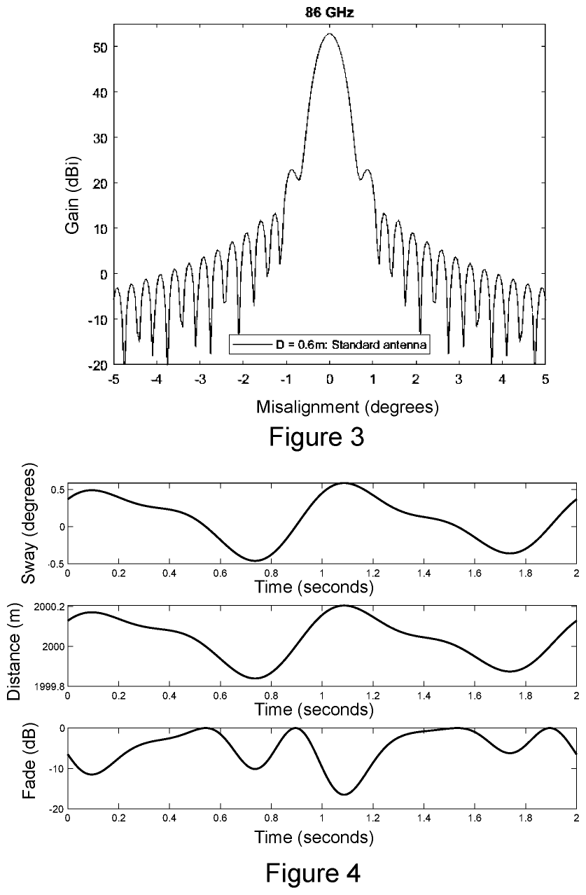

In what follows, a point-to-point link operating over a carrier frequency of 80 GHz with a transmission bandwidth of 1 GHz is considered. The hop length is 2 km. The first antenna structure 110 is a mast with a height is 20 m. Furthermore, the first antenna 120 is a 50 dBi antenna, with an element pattern as in FIG. 3.

FIG. 4 shows a random sway process over 2000 ms. The top part of FIG. 4 shows the sway (in degrees) of the first antenna structure 110. The middle part shows the corresponding distance between the transmitter and receiver (in meters), which are placed 2 km from each other. The bottom part of FIG. 4 shows the corresponding fade in dB. In this example, only one end of the link is swaying (i.e., one end is mounted to an immovable structure). Note that small sways, e.g., in the order of 0.5 degrees may lead to significant fading dips (i.e., loss in received power).

A signal transmitted at one side of the link will travel a distance d1+d2, where d1 is the hop length (2 km) and d2 is the path length difference, which is defined by the movement of the first antenna structure 110. For links operating at high frequencies, e.g., 80 GHz, the wavelength is very short (3.75 mm) and even a small movement will result in a measurable propagation delay.

In some embodiments, to allow the received to estimate the propagation delay, the transmitter sends a known (to both the transmitter and receiver) reference signal (i.e., a pilot sequence).

In this example, the pilot sequence is a length-96 cyclic extension of a length-89 Zadoff-Chu sequence, which is oversampled, at the transmitter, to span a duration of 1 μs and modulated onto a root-raised cosine filter. This known sequence is transmitted once every 5 ms. The receiver samples the signal at a rate of 32 GS/s.

Upon receiving the known sequence, the receiver may estimate the propagation delay difference, due to sway, from the received signal. Since the bandwidth is high even a small propagation delay may be detected (see, e.g., Tables 1 and 2).

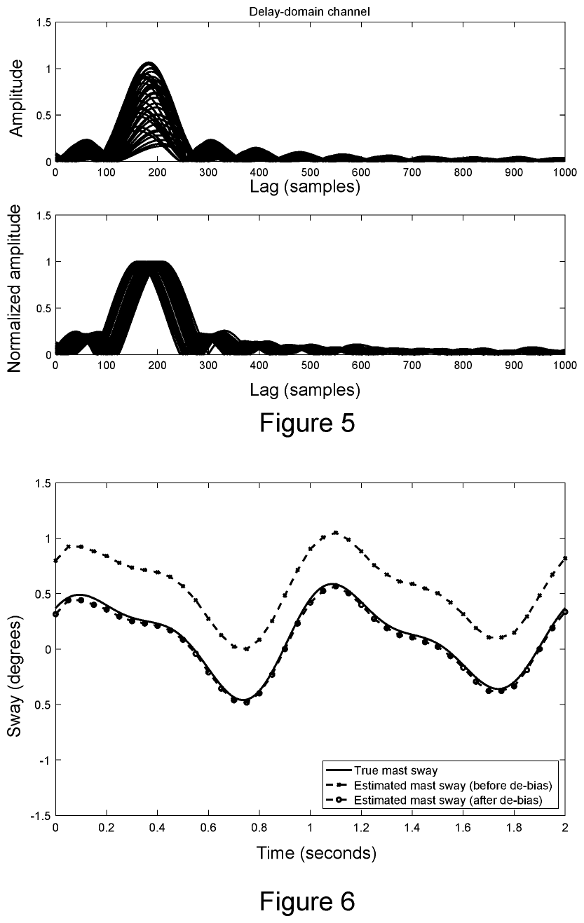

FIG. 5 shows the delay-domain response of the measured channel computed by matched filtering of the received frequency-domain signal with the known sequence followed by a DFT for different time instances. Here, the channel is measured every 5 ms (at which the known sequence is received) over 2 seconds. In FIG. 5, shows delay-domain response during sway before (top) and after (bottom) normalization of the amplitude. The mast sway leads to propagation delay (horizontal shift) and power loss (amplitude scaling). Therefore, the bottom part of the figure shows the normalized amplitude. Here, each curve corresponds to a different measurement.

By finding the lag lₘₐₓ(t_{meas,i}) for which the amplitude of the propagation delay response is maximized at measurement time t_{meas,i}, it is possible to estimate the corresponding propagation delay, τ_{meas,i}, as follows: τ_{meas,i}=lₘₐₓ(t_{meas,i})/f_{rx,samp}, where f_{rx,samp} is the sampling rate at the receiver. Based on this propagation delay estimate, it is possible to estimate the path-loss distance d2 as follows:

$$d 2 = c ( {τ}_{meas , i} - {min}_{i} {τ}_{meas , i} ) ,$$

where c is the speed of light, and “min” is the minimum over all measurement instances within some measurement interval. Finally, through trigonometry (assuming that the height of the first antenna structure 110 and hop length is known), or by a model of the first antenna structure 110, d2 at measurement i may be used to estimate the sway of the first antenna structure 110. The sway estimate using this approach may be biased. A simple way to de-bias the estimate is to measure the received power at the measurement instances and to offset the estimate by subtracting the sway at the measurement instance that yields the highest power (e.g., when the transmitter and receiver are most likely aligned).

Error!Reference source not found.6 shows the estimated sway (before and after de-biasing) along with the true sway. The delay-domain estimation technique presented in this example may be used to accurately track the sway. Note that, in this example, a high signal-to-noise-ratio scenario is considered (i.e., the noise power is small compared to the received signal power), which is typical for point-to-point link.

In case of a multiple-input-multiple-output (MIMO) system or a diversity system with horizontally separated antennas mounted on the same structure, the twist (in the horizontal plane) of the antenna structure may be detected by the difference in the propagation delay on both antennas. In the MIMO system, two or more antennas on the first antenna structure 110 is part of a MIMO radio unit. For example, in FIG. 2, the first antenna 120 and the third antenna 130 may share a single radio unit.

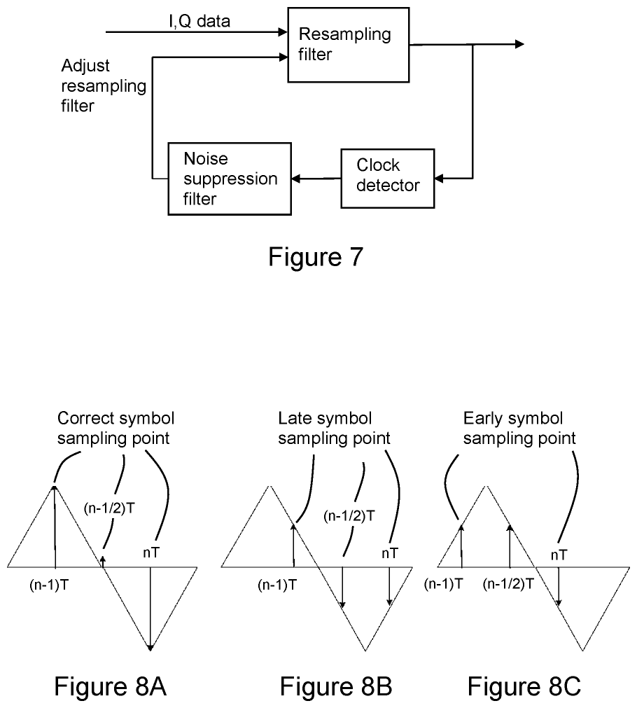

The calculation of the propagation delay may be done when channel estimation is done, or it may be a dedicated sequence that is scheduled when necessary. In microwave links there typically is a clock recovery filter used to address sample clock differences between the transmitter and the receiver. A typical design of a clock recovery filter comprises a resampling filter and a clock detector, see FIG. 7, which shows a block diagram of a clock recovery filter. The clock detector estimates how far the receiver is sampling the received signal from the optimal time instant, see FIGS. 8A-8C, which show correct sampling (left), late sampling (middle), and early sampling (right), and calculates a clock error. The detected clock error is filtered to reduce noise, and then passed as input to a resampling filter, which uses the detected clock error to resample the signal and compensate for the sampling error. The sway will cause a sampling error which will detected in the clock detector. By accumulate/integrate the clock/sampling error it is possible to be detect how much the antenna structure sways.

When both the first and the second antenna structures 110, 150 moves, propagation delay alone may not be enough to detect which sides of the link are swaying and by how much. This may be solved by equipping one side of the link with a motion sensor. For example, if there is propagation delay variation then there is movement on at least one side of the link. If movement is detected on the antenna structure comprising the motion sensor, it is possible to calculate the propagation delay associated with that movement from the motion sensor. The movement of the other antenna structure (without motion sensor) may then be calculated from the difference between the difference in propagation delay of the received signal and the calculated propagation delay based on the motion sensor. This solution has the advantage that only one motion sensor is required and only at one side of the link. The other side may have a regular antenna without any motion sensors.

If one end of the link is swaying, then the sway compensation may be done at that end where the sway occurs. However, if both ends of a link is swaying, then sway compensation should preferably be done at both ends. Simultaneous sway compensation on both ends presents a challenge since any compensation at one end will affect the compensation at the other end. A joint compensation control scheme may be used, which uses joint sway estimation and control of both ends. In some embodiments, joint sway estimation and control is done by the remote processing unit. Estimation and control signals need to be communicated to/from the remote data processing unit 170 over a reliable channel with low-enough latency. For example, a high-priority traffic queue communicated over a robust low-order modulation channel.

In some embodiments, multiple antennas are used for propagation delay estimation on one or both sides of the link as is shown in the example of FIG. 2. Separate or joint estimation and control may be done over multiple antennas. Joint propagation delay estimation based on multiple antennas achieves higher accuracy compared to if only one antenna is used. Modelling of sway in relation to the placement of the antennas on the antenna structure should be included since sway is typically larger higher up in the antenna structure. Information of antenna placement may thus improve the estimation accuracy. For example, if a small propagation delay (small sway) is estimated on an antenna mounted low on the antenna structure then it is expected that the sway is larger on antenna mounted further up in the antenna structure. The sway difference may be modelled and included in the joint estimation.

In situations with strong vertical temperature gradients in the air between the first and the second antennas 120, 150, the electromagnetic wave may travel in other trajectory between the two nodes instead of in a straight line. This is called atmospheric ducting (air at higher altitudes need to be warmer than air at lower altitudes for ducting to occur). As the trajectory with ducting is longer than the straight line between the nodes, ducting will result in an increased propagation delay. If considerable ducting occurs, the direction of arrival could change sufficiently to result in reduced received signal level. Ducting may, e.g., be identified by the combination of (i) motion sensors detect no movement, (ii) reduced received signal level, and (iii) increased propagation delay. Without (iii), ducting cannot be distinguished from, for example, rain. With ducting identified, steering of the antenna may be employed to restore the received signal level.

In some embodiments, Doppler-shift estimation is used to determine the movement of the first antenna structure 110 instead or in combination with using the difference in propagation delay. The Doppler-shift estimation may, e.g., be performed using known methods for Doppler estimation. In some embodiments, the link is equipped with a steerable antenna the model, where the model, which models the tilt angle of the first antenna 120 based on the estimated Doppler shift to maximize the received signal level. In some embodiments, the relation between Doppler shift estimation and the tilt angle of the first antenna 120 is known from, e.g., a physical model of the first antenna structure 110.

In some embodiments, the propagation delay and/or Doppler-shift estimation algorithms are only applied when the node has detected a sudden drop in received signal strength, which will save energy compared to having the algorithms always running. In other embodiments, in case the node is equipped with motion sensor to detect antenna movement, the propagation delay and/or Doppler estimation algorithms are only applied when the node has detected a sudden drop in received signal strength and detected a motion of the node (otherwise, it is most likely another node that has a moved, or it is rain).

In some embodiments, a receiving node of a link (that has determined that it does not move itself) estimates propagation delay and/or Doppler shift of received signals from a second transmitting node of the link and then signals the estimated difference in propagation delay and/or Doppler shift to the transmitting node. The transmitting node of receives the propagation delay/Doppler information, and based on this information determines a suitable antenna tilt angle to compensate for the movement of the first antenna structure 110.

In some embodiments, the movement of the first antenna structure 110 derived from one or more nodes that share the same antenna structure are collected at a central location (such as the remote data processing unit 170) and the total movement of that antenna structure is estimated. This may be shared with the nodes on that antenna structure so that the movement may be taken into account. For example, compensation of movement or in the case of Joint Communication and Sensing (JCAS), knowledge of the movement of the antenna structure may be important to incorporate in the calculation of UE position. Another example is distributed MIMO with phase coherent joint transmission (C-JT) between radio units on different sites, where it is important to also know when an antenna is moving.

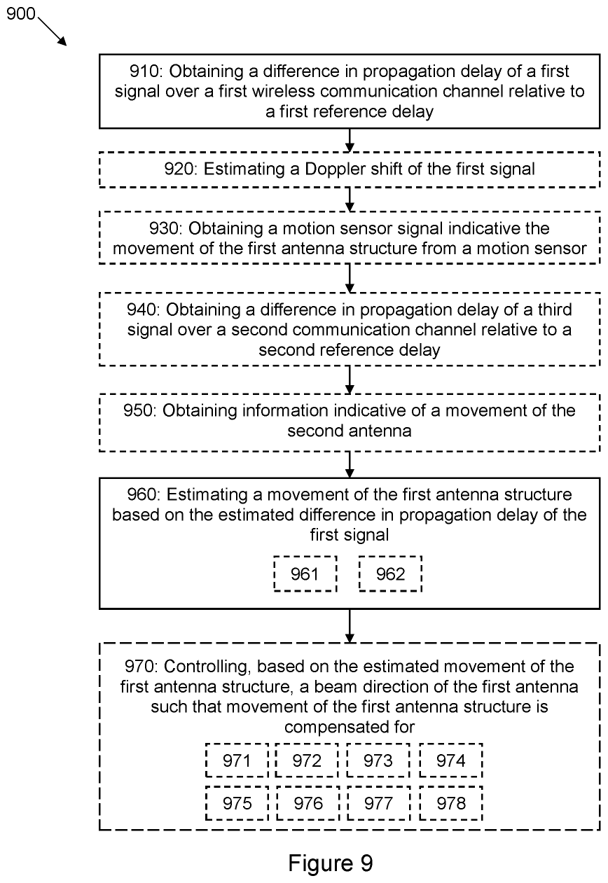

FIG. 9 illustrates a computer-implemented method 900 for enabling compensation of a movement of a first antenna structure 110 having a first antenna 120 mounted thereto. The first antenna 120 is configured to communicate with a second antenna 150 over a first wireless communication channel. The computer-implemented method 900 may be performed by a radio unit 125 associated with the first antenna 120 as shown in FIGS. 1A, 1B, and 2, or by a remote data processing unit 170 as shown in FIGS. 1A, 1B, and 2. The computer-implemented method 900 may comprise a number of actions listed below.

The computer-implemented method 900 is particularly suitable when at least the first antenna 120 is a directive antenna. However, in practice, most antennas have a non-constant radiation pattern and may benefit to some extent if it is directed to compensate movement of the first antenna structure 110 such that the link gain is maximized. As mentioned, the second antenna 150 may be a directive antenna or an omnidirectional antenna.

Action 910. The computer-implemented method 900 comprises obtaining a difference in propagation delay of a first signal over the first wireless communication channel relative to a first reference delay. The first signal may be transmitted by the second antenna 150 and be received by the first antenna 120. In that case, the first radio unit 125 may estimate the difference in propagation delay. Alternatively, the first signal is transmitted by the first antenna 120 and is received by the second antenna 150. In that case, the second radio unit 155 associated with the second antenna 150 may estimate the difference in propagation delay and communicate that information to the first radio unit 125 or to the remote data processing unit 170.

The first signal may be a reference signal. The reference signal may comprise a pilot sequence such as a Zadoff-Chu sequence. The reference signal may be transmitted repeatedly from the first antenna 120 to the second antenna 150 and/or from the second antenna 150 to the first antenna 120, for example every 5 ms. At least one of the reference signal is used to obtain the difference in propagation delay.

The first reference delay may, e.g., be obtained from when both the first and the second antenna structures 110, 140 are stationary, when the first and the second antennas 120, 150 are pointed to maximize the link gain, at a given weather condition. In that case, the reference delay may be obtained from theoretical calculations.

Alternatively, the first reference delay may be obtained from one or more previously communicated signals over the first wireless communication channel. The previously communicated signals may be obtained during installment of the link where the first and the second antenna structures 110, 140 are stationary and where the first and the second antennas 120, 150 are pointed to maximize the link gain. However, the first reference delay may change due to, e.g., ducting. Therefore, the first reference delay may be obtained continuously during deployment.

The one or more previously communicated signals over the first wireless communication channel may be selected based on their respective received signal strength. For example, one or more signals with maximum RSS may be selected. In this way, the difference in propagation delay is relative to a preferred direction of the beam direction of the first antenna 120. The difference in propagation delay may be used subsequently to redirect the beam direction of the first antenna 120 towards the preferred direction. If the first antenna structure 110 receives the first signal, the difference in propagation delay may be obtained by comparing the propagation delay of the first signal to the propagation delay of a previously received reference signal by the first antenna 120 that presents the highest RSS among a plurality of previously received reference signals by the first antenna 120.

Action 920. The computer-implemented method 900 may further comprise estimating a Doppler shift of the first signal. The estimated Doppler shift may be used as an additional input for controlling the beam direction of the first antenna 120. This is discussed in further detail below.

Action 930. The first antenna structure 110 may be provided with a motion sensor. In that case, the computer-implemented method 900 may comprise obtaining a motion sensor signal indicative the movement of the first antenna structure 110 from the motion sensor. The motion sensor signal may be used as additional input to the controlling of the beam direction, which is discussed in further detail below.

Action 940. In some embodiments, the first antenna structure 110 is provided with a third antenna 130 mounted thereto, where the third antenna is configured to communicate with the second antenna 150 or with a fourth antenna 160 over a second wireless communication channel. In that case, the computer-implemented method 900 may comprise obtaining a difference in propagation delay of a third signal over the second wireless communication channel relative to a second reference delay. The difference in propagation delay of the third signal may be used as additional input when estimating the movement of the first antenna structure 110, which is discussed in more detail below. The first and the third antennas may e.g. be part of a MIMO transceiver (i.e. be phase coherent). In that case, the first and the third antennas share the same radio unit. Alternatively, the first and third antennas are part of separate radio units, as shown in FIG. 2.

The third signal may be a reference signal. Such a reference signal may comprise a pilot sequence similar to the example pilot signal for the first signal discussed above.

In some scenarios, the second antenna 150 is mounted to a second antenna structure 140 that presents no movement, or small enough movement to have insignificant impact on the link gain. However, if the second antenna structure 140 moves by a significant amount, the movement will affect the propagation delay. In that case, it is desired to differentiate the movement of the first antenna structure 110 from the movement of the second antenna structure 140.

Action 950. The computer-implemented method 900 may comprise obtaining information indicative of a movement of the second antenna 150, wherein the first reference delay is based on the obtained information indicative of the movement of the second antenna 150. In this way, the reference delay accounts for the movement of the second antenna 150. Consequently, the movement of the first antenna structure 110 can be differentiated from the movement of the second antenna structure 140. The movement of the second antenna 150 may, e.g., be obtained from a motion sensor on the second antenna structure 140. Information of movement of the second antenna 150 may be obtained from a signal transmitted by the second antenna 150 to the first antenna 120 if the computer-implemented method 900 is performed by the first radio unit 125 associated with the first antenna 120. If the computer-implemented method 900 is performed by the remote data processing unit 170, the information may be communicated to the remote data processing unit 170 by the second antenna 150.

Action 960. The computer-implemented method 900 comprises estimating the movement of the first antenna structure 110 based on the estimated difference in propagation delay of the first signal. The estimated difference in propagation delay may be used to estimate a difference in path loss distance, such as d2 in FIG. 1B, which is a movement of the first antenna structure 110. The estimated movement of the first antenna structure 110 is relative to a position of the first antenna structure 110 associated with the first reference delay. In some examples, the estimated movement is relative to when the first antenna structure 110 is stationary.

Action 961. The estimation of the movement of the first antenna structure 110 may comprise estimating a tilt angle φ of the beam direction 121 of the first antenna 120 relative to a reference direction based on the estimated difference in propagation delay of the first signal. The tilt angle φ may, e.g., be estimated using trigonometry and the dimensions of the first antenna structure 110. However, the tilt angle may vary non-linearly with the difference in path loss distance (or equivalently the difference in propagation delay). In that case, estimating a linear behavior of the tilt angle versus the difference in path loss distance and using trigonometry may still be used to obtain an estimation of the tilt angle that can be used to compensate for the movement of the first antenna structure 110 to some extent. However, more complex models of the antenna structure, which e.g. captures non-linear behavior of the tilt angle versus the distance d2, may be alternatively be used. In particular, the tilt angle φ may be estimated from an empirical or a physical model describing movement of the first antenna structure 110 versus difference in propagation delay (or equivalently versus the difference in path loss distance). An empirical model is a model formed by observation and experiment. A physical model is model based on physical properties of the antenna structure, such as dimensions, antenna placement, bending properties of the antenna structures etc. The empirical or a physical model takes the difference in propagation delay of the first signal as input, and outputs the tilt angle φ.

How the tilt angle is affected by the movement of the first antenna structure 110 may depend, e.g., on temperature differences in the first antenna structure 110. Consequently, the empirical or a physical model used to determine the tilt angle based on the delay may also depend on the estimated temperature differences in the first antenna structure 110.

The reference direction may be a line of sight from first antenna 120 to the second antenna 150. However, the reference direction may in general be the direction that yields the highest link gain, which may be different from the line of sight due to ducting and/or refractivity in the atmosphere. Refractivity in the atmosphere may bend the beam either up or down relative to the line of sight. This phenomenon is usually expressed by the so-called K-factor. In any case, the reference direction may be obtained from one or more previously received signals by the first antenna 120 transmitted from the second antenna 150. The one or more previously received signals used to obtain the reference direction may be the same signals used to obtain the first reference delay. The one or more previously received signals may be selected based on their respective received signal strength. For example, the signal with maximum RSS may be selected. In this way, the estimated tilt angle may be used subsequently to redirect the beam direction of the first antenna 120 towards the direction providing maximum link gain.

Action 962. If Action 940 is performed, the estimation of the movement of the first antenna structure 110 may comprise estimating the movement of the first antenna structure 110 based on the estimated difference in propagation delay of the third signal. Such additional information provides a better estimation of movement of the first antenna structure 110. In addition, such additional information facilitates estimating more complex motion of the first antenna structure 110, such as twisting, which enables better compensation of the movement when the beam direction of the first antenna 120 is controlled based on the estimation movement of the first antenna structure 110.

Action 970. The computer-implemented method 900 may comprise controlling, based on the estimated movement of the first antenna structure 110, a beam direction 121 of the first antenna 120 such that the movement of the first antenna structure 110 is compensated for. In this way, a higher link gain may be obtained.

Action 971. The controlling of the beam direction 121 of the first antenna 120 may comprise controlling the beam direction 121 of the first antenna 120 based on the estimated tilt angle φ, estimated during Action 961.

The estimated tilt angle φ may be used to tilt the beam direction by an amount corresponding to φ with an opposite sign. Thus, the beam direction of the first antenna 120 is controlled in an opposite direction of the movement that caused the difference in propagation delay of the first signal. As mentioned, since longitudinal tilting of the first antenna structure 110 is a large contributor to variations in the link gain. Therefore, in some embodiments, the first antenna 120 is capable of adapting the beam direction in the vertical direction. In that case, the estimated tilt angle φ is in the vertical direction, and the beam direction 121 is controlled in the vertical direction.

Action 972, 973, and 974. As mentioned, the computer-implemented method 900 may comprise fine tuning of the beam direction of the first antenna 120 based on a received signal strength scan. The controlling of the beam direction 121 of the first antenna 120 may therefore iteratively comprise: receiving 972, by the first antenna 120, a second signal transmitted from the second antenna 150; estimating 973 a received signal strength of the second signal; and controlling 974 the beam direction 121 of the first antenna 120 based on the estimated received signal strength.

The second signal may be a reference signal. Such a reference signal may comprise a pilot sequence similar to the example pilot signal for the first signal discussed above. As mentioned, the second antenna 150 may continuously send reference signals to the first antenna 120. One of the continuously sent reference signals may be selected as the first signal, and subsequent reference signals may be used, as the second signal, to scan the beam direction of the first antenna 120 to find maximum RSI.

Action 975. The first antenna 120 may be mechanically steerable. In that case, the controlling of the beam direction 121 of the first antenna 120 may comprise controlling the beam direction 121 of the first antenna 120 by mechanically steering the first antenna 120.

Action 976. The first antenna 120 may be electronically steerable. In that case, the controlling of the beam direction 121 of the first antenna 120 may comprise controlling the beam direction 121 of the first antenna 120 by electrically steering the first antenna 120.

The first antenna 120 may also be an antenna being both mechanically and electronically steerable.

As mentioned, the computer-implemented method 900 is usable even without a steerable antenna. For example the estimated movement of the first antenna structure 110 can be used to detect which sites in a network that have sway issues, i.e., to determine if movement of the first antenna structure 110 causes an undesired amount of variation in link gain. Once such problem is identified, the first antenna 120 may be upgraded to be a steerable antenna.

Action 977. If the Doppler shift of the first signal has been estimated at Action 920, the computer-implemented method 900 further comprises controlling the beam direction 121 of the first antenna 120 based on the estimated Doppler shift. Such additional information provides a better estimation of movement of the first antenna structure 110.

Action 978. The controlling of the beam direction 121 of the first antenna 120 may comprise controlling the beam direction 121 of the first antenna 120 based on the obtained motion sensor signal, if the motion sensor signal is obtained at Action 930. Such additional information provides a better estimation of movement of the first antenna structure 110. Furthermore, an inexpensive and less accurate motion sensor may be used relative to a case where only a motion sensor is used to estimate motion of the first antenna structure 110 (without using the difference in propagation delay). The difference in propagation delay of the first signal may e.g. be used to compensate for sensor drift of the motion sensor. Alternatively, or in combination of, slow movements of the antenna structure may be estimated using the motion sensor and faster movements of the antenna structure may be estimated using the difference in propagation delay of the first signal.

Furthermore, if the motion sensor signal is obtained at Action 930, the obtaining of the difference in propagation delay of the first signal, the estimation of the movement of the first antenna structure 110, and the controlling of the beam direction of the first antenna 120 may be performed when the obtained motion sensor signal indicates movement of the first antenna structure 110 being larger than a threshold. In other words, the mentioned actions are only applied when the motion sensor indicates a significant movement of the first antenna structure 110. In this way, energy is saved. In other embodiments, the mentioned actions are only applied when a sudden drop in received signal strength is detected, which also will save energy.

There is also disclosed herein a node 125, 170 for enabling compensation of a movement of a first antenna structure 110 having a first antenna 120 mounted thereto. The first antenna is configured to communicate with a second antenna 150 over a first wireless communication channel. The node may, e.g., be the first radio unit 125 or the remote data processing unit 170.

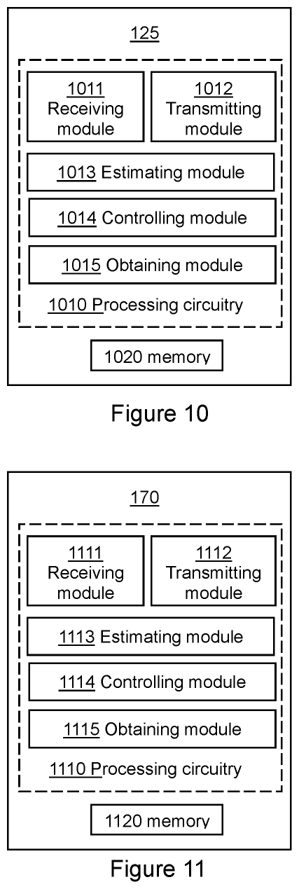

FIG. 10 shows a schematic block diagram of embodiments of a first radio unit 125 and FIG. 11 shows a schematic block diagram of embodiments of a remote data processing unit 170. The embodiments of the node 110, 140 may be considered as independent embodiments or may be considered in any combination with each other. It should also be noted that, although not shown in FIGS. 11 and 12, the node 110, 170 may comprise known conventional features for such devices, such as a power source like a battery or mains connection, or an antenna arrangement.

The node 125, 170 may comprise processing circuitry 1110, 1210 and a memory 1020, 1120. The processing circuitry 1110, 1210 may comprise a receiving module 1011, 1111 and a transmitting module 1012, 1112. The receiving module 1011, 1111 and the transmitting module 1012, 1112 may comprise radio frequency circuitry and baseband processing circuitry capable of transmitting and receiving a radio signal in the wireless communications network 100. The receiving module 1011 and the transmitting module 1012 may also form part of a single transceiver. It should also be noted that some or all of the functionality described in the embodiments above as being performed by the node 125, 170 may be provided by the processing circuitry 1010, 1110 executing instructions stored on a computer-readable medium, such as, e.g. the memory 1020, 1120 shown in FIGS. 10 and 11, respectively. Alternative embodiments of the node 125, 170 may comprise additional components, such as, an estimating module 1013, 1113, a controlling module 1014, 1114, and/or an obtaining module 1015, 1115, responsible for providing functionality to support the embodiments of the node described herein.

The node 125, 170, the processing circuitry 1110, 1210, or the obtaining module 1015, 1115 is configured to obtain a difference in propagation delay of a first signal over the first wireless communication channel relative to a first reference delay.

The node 125, 170, the processing circuitry 1110, 1210, or the estimating module 1013, 1113 is configured to estimate the movement of the first antenna structure 110 based on the estimated difference in propagation delay of the first signal.

In some embodiments, the node 125, 170, the processing circuitry 1110, 1210, or the controlling module 1014, 1114 is configured to control, based on the estimated movement of the first antenna structure 110, a beam direction 121 of the first antenna 120 such that the movement of the first antenna structure 110 is compensated for.

In some embodiments, the node 125, 170, the processing circuitry 1110, 1210, or the estimating module 1013, 1113 is configured to estimate a tilt angle φ of the beam direction 121 of the first antenna 120 relative to a reference direction based on the estimated difference in propagation delay of the first signal. In that case, the node 125, 170, the processing circuitry 1110, 1210, or the controlling module 1014, 1114 is configured to control the beam direction 121 of the first antenna 120 based on the estimated tilt angle φ.

In some embodiments, the tilt angle φ is estimated from an empirical or a physical model describing movement of the first antenna structure 110 versus difference in propagation delay.

In some embodiments, the reference direction is a line of sight from first antenna 120 to the second antenna 150. Furthermore, the reference direction may be obtained from one or more previously received signals by the first antenna 120 transmitted from the second antenna 150. In some embodiments, the one or more previously received signals are selected based on their respective received signal strength.

In some embodiments, the first reference delay is obtained from one or more previously communicated signals over the first wireless communication channel. Furthermore, the one or more previously communicated signals over the first wireless communication channel may be selected based on their respective received signal strength.

In some embodiments, In some embodiments, the node 125, 170, the processing circuitry 1110, 1210, the receiving module 1011, estimating module 1013, 1113, and/or the controlling module 1014, 1114 is configured to, iteratively, receive, by the first antenna 120, a second signal transmitted from the second antenna 150; estimate a received signal strength of the second signal; and control the beam direction 121 of the first antenna 120 based on the estimated received signal strength.

In some embodiments, the first antenna 120 is mechanically steerable. In that case, the node 125, 170, the processing circuitry 1110, 1210, or the controlling module 1014, 1114 may be configured to control the beam direction 121 of the first antenna 120 by mechanically steering the first antenna 120.

In some embodiments, the first antenna 120 is electronically steerable. In that case, the node 125, 170, the processing circuitry 1110, 1210, or the controlling module 1014, 1114 may be configured to control the beam direction 121 of the first antenna 120 by electrically steering the first antenna 120.

In some embodiments, the node 125, 170, the processing circuitry 1110, 1210, or the estimating module 1013, 1113 is configured to estimate a Doppler shift of the first signal. In that case, the node 125, 170, the processing circuitry 1110, 1210, or the controlling module 1014, 1114 is configured to control the beam direction 121 of the first antenna 120 based on the estimated Doppler shift.

In some embodiments, the first antenna structure 110 is provided with a motion sensor. In that case, the node 125, 170, the processing circuitry 1110, 1210, or the obtaining module 1015, 1115 may be configured to obtain a motion sensor signal indicative the movement of the first antenna structure 110 from the motion sensor. Furthermore, the node 125, 170, the processing circuitry 1110, 1210, or the controlling module 1014, 1114 may be configured to control the beam direction 121 of the first antenna 120 based on the obtained motion sensor signal.

If the first antenna structure 110 is provided with a motion sensor, and a motion sensor signal indicative the movement of the first antenna structure 110 is obtained from the motion sensor, the processing circuitry 1010, 1110 may be configured to control the beam direction of the first antenna 120 when the obtained motion sensor signal indicates movement of the first antenna structure 110 being larger than a threshold.

In some embodiments, the first antenna structure 110 is provided with a third antenna 130 mounted thereto, where the third antenna is configured to communicate with the second antenna 150 or with a fourth antenna 160 over a second wireless communication channel. In that case, the node 125, 170, the processing circuitry 1110, 1210, or the obtaining module 1015, 1115 may be configured to obtain a difference in propagation delay of a third signal over the second wireless communication channel relative to a second reference delay. Furthermore, the node 125, 170, the processing circuitry 1110, 1210, or the estimating module 1013, 1113 may be configured to estimate the movement of the first antenna structure 110 based on the estimated difference in propagation delay of the third signal.

In some embodiments, the node 125, 170, the processing circuitry 1110, 1210, or the obtaining module 1015, 1115 is configured to obtain information indicative of a movement of the second antenna 150. In that case, the first reference delay may be based on the obtained information indicative of the movement of the second antenna 150.

In some embodiments, the first signal is a reference signal, the second signal is a reference signal, and/or the third signal is a reference signal.

The methods disclosed herein may be implemented through one or more processors, such as the processing circuitry 1010 in the first radio unit 125 depicted in FIG. 10 or the processing circuitry 1110 in the remote data processing unit 170 depicted in FIG. 11, together with computer program code for performing the functions and actions of the embodiments herein. The program code may also be provided as a computer program product, for instance in the form of a data carrier carrying computer program code or code means for performing the embodiments herein when being loaded into the processing circuitry 1010, 1110 in the node 125, 170. The computer program code may e.g. be provided as pure program code in the node 125, 170 or on a server and downloaded to the node 125, 170. Thus, it should be noted that the modules of the node 125, 170 may in some embodiments be implemented as computer programs stored in memory, e.g. in the memory 1020 or 1120 in FIGS. 10 and 11, respectively, for execution by processors or processing modules, e.g. the processing circuitry 1010 or 1110 of FIGS. 10 and 11, respectively. Those skilled in the art will also appreciate that the processing circuitry 1010, 1110 and the memory 1020, 1120 described above may refer to a combination of analog and digital circuits, and/or one or more processors configured with software and/or firmware, e.g. stored in a memory, that when executed by the one or more processors such as the processing circuitry 1010, 1110 perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

It should also be noted that the various example embodiments described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The embodiments herein are not limited to the above-described preferred embodiments. Various alternatives, modifications and equivalents may be used. Therefore, the above embodiments should not be construed as limiting.

1. A computer-implemented method for enabling compensation of a movement of a first antenna structure having a first antenna mounted thereto, wherein the first antenna is configured to communicate with a second antenna over a first wireless communication channel, the method comprising:
obtaining a difference in propagation delay of a first signal over the first wireless communication channel relative to a first reference delay; and
estimating the movement of the first antenna structure based on the estimated difference in propagation delay of the first signal.

2. The computer-implemented method according to claim 1, comprising:
controlling, based on the estimated movement of the first antenna structure, a beam direction of the first antenna such that the movement of the first antenna structure is compensated for.

3. The computer-implemented method according to claim 2, wherein estimation of the movement of the first antenna structure comprises:
estimating a tilt angle (φ) of the beam direction of the first antenna relative to a reference direction based on the estimated difference in propagation delay of the first signal, and wherein the controlling of the beam direction of the first antenna comprises controlling the beam direction of the first antenna based on the estimated tilt angle (φ).

4. The computer-implemented method according to claim 3, wherein the tilt angle (φ) is estimated from an empirical or a physical model describing movement of the first antenna structure versus difference in propagation delay.

5. The computer-implemented method according to claim 3, wherein the reference direction is a line of sight from first antenna to the second antenna.

6. The computer-implemented method according to claim 3, wherein the reference direction is obtained from one or more previously received signals by the first antenna transmitted from the second antenna.

7. The computer-implemented method according to claim 6, wherein the one or more previously received signals are selected based on their respective received signal strength.

8. The computer-implemented method according to claim 1, wherein the first reference delay is obtained from one or more previously communicated signals over the first wireless communication channel.

9. The computer-implemented method according to claim 8, wherein the one or more previously communicated signals over the first wireless communication channel are selected based on their respective received signal strength.

10. The computer-implemented method according to claim 2, wherein the controlling of the beam direction of the first antenna iteratively comprises:
receiving, by the first antenna, a second signal transmitted from the second antenna;
estimating a received signal strength of the second signal; and
controlling the beam direction of the first antenna based on the estimated received signal strength.

11. The computer-implemented method according to claim 2, wherein the first antenna is mechanically steerable, and wherein the controlling of the beam direction of the first antenna comprises:
controlling the beam direction of the first antenna by mechanically steering the first antenna.

12. The computer-implemented method according to claim 2, wherein the first antenna is electronically steerable, and wherein the controlling of the beam direction of the first antenna comprises:
controlling the beam direction of the first antenna by electrically steering the first antenna.

13. The computer-implemented method according to claim 2, comprising:
estimating a Doppler shift of the first signal, wherein the controlling of the beam direction of the first antenna comprises:
controlling the beam direction of the first antenna based on the estimated Doppler shift.

14. The computer-implemented method according to claim 2, wherein the first antenna structure is provided with a motion sensor, wherein the method comprises:
obtaining a motion sensor signal indicative the movement of the first antenna structure from the motion sensor, wherein the controlling of the beam direction of the first antenna comprises:
controlling the beam direction of the first antenna based on the obtained motion sensor signal.

15. The computer-implemented method according to claim 2, wherein the first antenna structure is provided with a motion sensor, wherein the method comprises:
obtaining a motion sensor signal indicative the movement of the first antenna structure from the motion sensor;
wherein the obtaining of the difference in propagation delay of the first signal, the estimation of the movement of the first antenna structure, and the controlling of the beam direction of the first antenna are performed when the obtained motion sensor signal indicates movement of the first antenna structure being larger than a threshold.

16. The computer-implemented method according to claim 1, wherein the first antenna structure is provided with a third antenna mounted thereto, wherein the third antenna is configured to communicate with the second antenna or with a fourth antenna over a second wireless communication channel, wherein the method comprises:
obtaining a difference in propagation delay of a third signal over the second wireless communication channel relative to a second reference delay, wherein the estimation of the movement of the first antenna structure comprises:
estimating the movement of the first antenna structure based on the estimated difference in propagation delay of the third signal.

17. The computer-implemented method according to claim 1, comprising:
obtaining information indicative of a movement of the second antenna, wherein the first reference delay is based on the obtained information indicative of the movement of the second antenna.

18. The computer-implemented method according to claim 1, wherein the first signal is a reference signal.

19. (canceled)

20. The computer-implemented method according to claim 1, wherein the computer-implemented method is performed by a radio unit associated with the first antenna or a remote data processing unit.

21. (canceled)

22. A node for enabling compensation of a movement of a first antenna structure having a first antenna mounted thereto, wherein the first antenna is configured to communicate with a second antenna over a first wireless communication channel, and wherein the node comprises a processing circuitry and a memory, wherein the processing circuitry is configured to:
obtain a difference in propagation delay of a first signal over the first wireless communication channel relative to a first reference delay; and
estimate the movement of the first antenna structure based on the estimated difference in propagation delay of the first signal.

23-44. (canceled)
